(19) United States
(12) Patent Application Publication
(10) Pub. No.: US 2016/0340842 A1
(43) Pub. Date: Nov. 24, 2016

(54) MILLING SYSTEM

(71) Applicant: Caterpillar Paving Products Inc., Brooklyn Park, MN (US)

(72) Inventor: Kevin M. Adams, Maple Grove, MN (US)

(73) Assignee: Caterpillar Paving Products Inc., Brooklyn Park, MN (US)

(21) Appl. No.: 15/230,742

(22) Filed: Aug. 8, 2016

(51) Int. Cl. E01C 23/088; G08G 1/16; G05D 1/00; E01C 23/12; B64C 39/02

(52) U.S. Cl. CPC E01C 23/088; E01C 23/127; B64C 39/024; G05D 1/0011; G08G 1/161; B64C 2201/12

(57) ABSTRACT

A milling system for a milling machine operating on a ground surface is provided. The milling system includes an Unmanned Aerial Vehicle (UAV) communicably coupled to the milling machine. The UAV is configured to scan and penetrate a portion of the ground surface proximate to the milling machine along a first direction. The UAV is also configured to detect if an object is present beneath the portion of the ground surface. The UAV is further configured to transmit data associated with the object, if the object is detected beneath the portion of the ground surface. The milling system also includes a controller communicably coupled to the UAV and the milling machine. The controller is configured to receive the data associated with the object. The controller is also configured to control an operation of a rotor of the milling machine based on the received data.

### TECHNICAL FIELD

The present disclosure relates to a milling system, and more particularly to the milling system associated with a milling machine.

### BACKGROUND

Milling machines are used for scarifying, removing, mixing, or reclaiming material from grounds, roadbeds, and similar surfaces. The milling machines, such as cold planers and rotary mixers, include a rotor that is encased within a rotor chamber. During a cutting operation, the rotor is lowered into the ground for removing materials from the ground. The rotor includes a cylindrical drum and a number of cutting tools mounted on the cylindrical drum. During cutting operations, the cutting tools contact the ground to remove material from the ground.

In milling and reclamation environments, there is a need to detect objects or obstacles, i.e. sewer, pipes, man holes, etc., so that contact of the rotor with these objects may be avoided. Since these objects may sometimes lie below the ground, it may be difficult to observe these objects. Hence, during operation, the cutting tools present on the rotor of the milling machine may come in contact with these objects, which is undesirable. This may cause increase in machine downtime and high operating costs, affecting an overall efficiency of the milling machine.

U.S. Published Application Number 2016/016663 describes an automotive drone deployment system that includes at least a vehicle and a deployable drone that is configured to attach and detach from the vehicle. More specifically, the disclosure describes the vehicle and drone remaining in communication with each other to exchange information while the vehicle is being operated in an autonomous driving mode so that the vehicle's performance under the autonomous driving mode is enhanced.

### SUMMARY OF THE DISCLOSURE

In one aspect of the present disclosure, a milling system for a milling machine operating on a ground surface is provided. The milling machine travels in a first direction on the ground surface. The milling system includes an Unmanned Aerial Vehicle (UAV) communicably coupled to the milling machine. The UAV includes a control module and a sensing element. The UAV is configured to scan and penetrate a portion of the ground surface proximate to the milling machine along the first direction. The UAV is also configured to detect if an object is present beneath the portion of the ground surface, based on the scanning. The UAV is further configured to transmit data associated with the object, if the object is detected beneath the portion of the ground surface. The milling system also includes a controller communicably coupled to the UAV and the milling machine. The controller is configured to receive the data associated with the object. The controller is also configured to control an operation of a rotor of the milling machine based on the received data, such that the rotor is operated in a manner so as to avoid contact with the object.

Other features and aspects of this disclosure will be apparent from the following description and the accompanying drawings.

### BRIEF DESCRIPTION OF THE DRAWINGS

FIG. 1 is a side view of an exemplary milling machine and an Unmanned Aerial Vehicle (UAV) operating at a worksite, according to various concepts of the present disclosure and

FIG. 2 is a block diagram of a milling system associated with the milling machine of FIG. 1, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

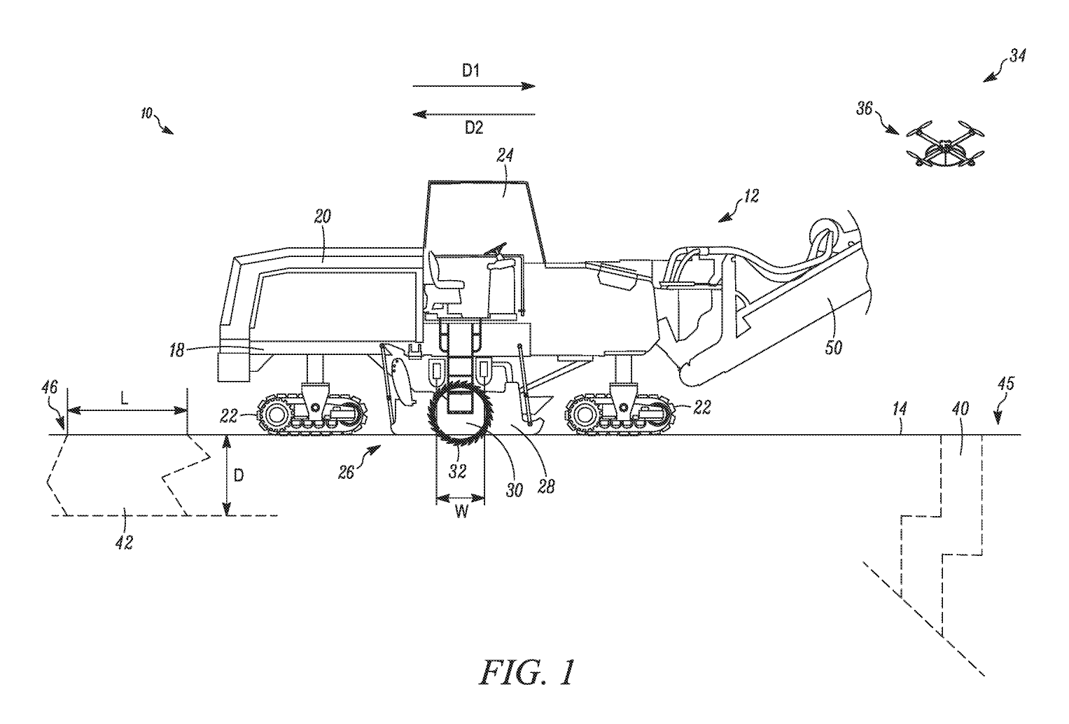

Referring to FIG. 1, an exemplary worksite 10 is illustrated. The worksite 10 may embody a roadway under maintenance, such as an asphalt roadway. Further, the worksite 10 may also embody a mining worksite, such as an underground mining worksite. Alternatively, the worksite 10 may include any other construction worksite known in the art, without limiting the scope of the present disclosure.

A milling machine 12 operates on aground surface 14 of the worksite 10. The milling machine 12 is a cold planer. Alternatively, the milling machine 12 may embody another machine, such as a rotary mixer, that removes materials, for example asphalt, from the ground surface 14 or roadbed. For explanatory purposes, only one milling machine 12 is shown operating at the worksite 10, however, a number of machines operating at the worksite 10 may vary based on system requirements.

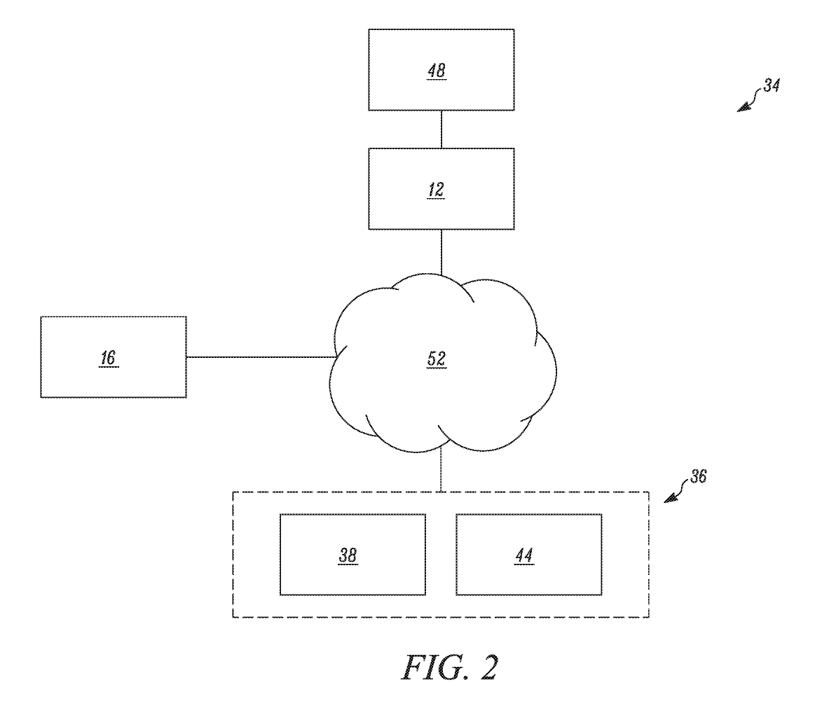

The milling machine 12 may be autonomous, semi-autonomous, or manually operated machine. In an example in which the milling machine 12 is autonomous or semi-autonomous, an operator seated at a remote operator station 16 (see FIG. 2) may operate the milling machine 12. The remote operator station 16 may be a base station that is located at the worksite 10 or at a location that is distant from the worksite 10.

The milling machine 12 includes a frame 18. An engine enclosure 20 is supported on the frame 18 for mounting of an engine (not shown). The engine is generally an internal combustion engine and provides propulsion power to the milling machine 12 and also powers various components of the milling machine 12.

The milling machine 12 includes a pair of tracks 22. The tracks 22 allow movement of the milling machine 12 on the ground surface 14. The tracks 22 allow the milling machine 12 to travel in a first direction “D1”, which is illustrated as a forward direction in this embodiment. Further, the machine may also move in a reverse direction. The tracks 22 may be driven by a hydraulic system of the milling machine 12. In another example, the milling machine 12 may include wheels (not shown) instead of the tracks 22.

The milling machine 12 includes an operator cabin 24. When the milling machine 12 is a manually operated machine, an operator of the milling machine 12 may sit in the operator cabin 24 to operate the milling machine 12. The operator cabin 24 is supported on the frame 18 of the milling machine 12.

Further, the milling machine 12 includes a rotor chamber 26. The rotor chamber 26 includes a first side plate 28 and a second side plate (not shown) provided at either sides of the milling machine 12. A height-adjustable rotor 30, hereinafter referred as rotor 30, is supported by the rotor chamber 26. The rotor 30 is positioned between the first side plate 28 and the second side plate. Further, the rotor 30 is enclosed by the first side plate 28 and the second side plate.

The rotor 30 is a generally cylindrical drum having a number of cutting tools 32. During a milling operation, the cutting tools 32 contact the ground surface 14 and removes material therefrom. The rotor 30 can be raised or lowered so as to remove various widths and depths of material from the ground surface 14. The rotor 30 may be movable by the hydraulic system of the milling machine 12. The removed material is loaded onto a transport vehicle (not shown) by a transport conveyor 50 for further transportation thereof.

The present disclosure is directed towards a milling system 34. The milling system 34 will now be explained in detail. For explanatory purposes, the milling system 34 will be explained in reference to the milling machine 12, without any limitations. However, it should be noted that the milling system 34 may additionally monitor other machines that operate at the worksite 10, without limiting the scope of the present disclosure.

Referring to FIGS. 1 and 2, the milling system 34 includes an Unmanned Aerial Vehicle (UAV) 36. The UAV 36 is communicably coupled to the milling machine 12 and the remote operator station 16. In one example, the UAV 36 may embody a commercial drone that hovers at the worksite 10. The UAV 36 may embody any powered, aerial vehicle without a human pilot aboard that hovers at the worksite 10. The UAV 36 may be remotely operated by the operator at the remote operator station 16 or the operator seated in the operator cabin 24. In another example, the UAV 36 can be autonomous or semi-autonomous. The range and altitude of the UAV 36 may be decided based on the requirements at the worksite 10.

In other embodiments, the UAV 36 may include additional components (not shown) such as a GPS receiver, Inertial Measurement Units (IMU), etc., for desired functioning of the UAV 36, without limiting the scope of the present disclosure. The UAV 36 may dock on the milling machine 12 when the milling machine 12 is not in operation. The UAV 36, when docked, can be connected to a data system associated with the milling machine 12 for data download and upload. The UAV 36 also includes a power source (not shown) that powers the UAV 36. When the UAV 36 is docked on the milling machine 12, the UAV 36 can connect to an electrical system for charging the power source of the UAV 36.

Referring to FIGS. 1 and 2, the UAV 36 includes a sensor 38. The sensor 38 scans and penetrates a first portion 45 of the ground surface 14 proximate to the milling machine 12 along the first direction “D1”. Accordingly, the UAV 36 may make use of RADAR or any other suitable technology to perform the scanning. During scanning, the sensor 38 of the UAV 36 detects if an object 40 is present beneath the around surface 14. The object 40 may include sewer pipes, electric cables, man holes, etc. extending beneath the ground surface 14. In the illustrated embodiment, the object 40 is a sewer pipe. More particularly, when the milling machine 12 operates in the first direction “D1”, the sensor 38 scans and penetrates the ground surface 14 in front of the milling machine 12. Further, when the milling machine 12 operates in the reverse direction, the sensor 38 scans the ground surface 14 behind the milling machine 12. In one example, the sensor 38 scans a radius of approximately 50 m to 1000 m surrounding the milling machine 12.

When the sensor 38 detects the presence of the object 40 beneath the ground surface 14, the sensor 38 generates a first signal. The first signal is indicative of the presence of the object 40 beneath the ground surface 14. In one example, the UAV 36 may scan the first portion 45 of the ground surface 14 when the milling machine 12 is in operation. In another example, the UAV 36 may scan the first portion 45 of the ground surface 14 either before the milling machine 12 starts operating or after the milling machine 12 has finished performing the intended operation, based on system requirements.

The sensor 38 of the UAV 36 may additionally scan and penetrate a second portion 46 of the around surface 14 along a second direction “D2”. The second direction “D2” is different from the first direction “D1”. In the illustrated embodiment, the second direction “D2” is opposite to the first direction “D1”. Alternatively, the second direction “D2” may be perpendicular to the first direction “D1”, without any limitations. The second portion 46 includes a final cut 42 formed by the milling machine 12. More particularly, the sensor 38 scans the final cut 42 to determine one or more characteristics of the final cut 42, such as, a length “L”, width, and a depth “D” of the final cut 42, When the sensor 38 determines the characteristics of the final cut 42, the sensor 38 generates a second signal indicative of the characteristics of the final cut 42. The UAV 36 may scan the second portion 46 of the ground surface 14 either when the milling machine 12 is in operation and has finished milling some portion of the ground surface 14 or after the milling machine 12 has finished performing the milling operation.

The sensor 38 is selected such that the sensor 38 is capable of identifying the object 40 beneath the ground surface 14 and also the characteristics of the final cut 42. The sensor 38 is mounted at a location on the UAV 36 such that a field of view of the sensor 38 may have minimum or no obstructions.

Further, the UAV 36 includes a control module 44 (see FIG. 2). The control module 44 is communicably coupled with the sensor 38. The control module 44 is also communicably coupled with the milling machine 12 and the remote operator station 16. The control module 44 is capable of processing signals from each of the sensor 38, the milling machine 12, and the remote operator station 16.

In one example, the control module 44 may be in communication with the milling machine 12 and the remote operator station 16 in a wireless manner. In such an example, a communication network 52 may allow communication between the control module 44 and the milling machine 12 and/or the remote operator station 16. The communication network 52 may embody a network that is capable of receiving and transmitting information from the milling machine 12 at the worksite 10, the control module 44, and the remote operator station 16, without limiting the scope of the present disclosure.

The communication network 52 may include, but is not limited to, a wide area network (WAN), a local area network (LAN), an Ethernet, an internet, an intranet, a cellular network, a satellite network, or any other network for transmitting data between the milling machine 12 and the remote operator station 16. In various examples, the communication network 52 may include a combination of two or more of the aforementioned networks and/or other types of networks known in the art. The network may be implemented as a wired network, a wireless network, or a combination thereof. Further, the data may be transmitted over the communication network 52 with a network protocol, for example, in an encrypted format, or any other secure format known in the art.

In another example, the control module 44 may be in communication with the milling machine 12 and/or the remote operator station 16 in a wired manner. In such an example, the control module 44 and the milling machine 12 and/or the remote operator station 16 may communicate when the UAV 36 is docked on the milling machine 12 and/or the remote operator station 16.

The control module 44 receives the first signal indicative of the presence of the object 40 beneath the ground surface 14 from the sensor 38. Based on the receipt of the first signal, the control module 44 transmits data pertaining to the presence of the object 40 to the milling machine 12 and/or the remote operator station 16. In one example, the control module 44 may determine a distance between the milling machine 12 or the rotor 30 and the object 40, based on receipt of the first signal. In some examples, the control module 44 may also determine a size or dimensions of the object 40 and communicate this data to the milling machine 12 or the remote operator station 16.

The milling system 34 includes a controller 48 (see FIG. 2). The controller 48 is communicably coupled to the UAV 36 and the milling machine 12. The controller 48 may be present on the milling machine 12 or at the remote operator station 16. In the illustrated embodiment, the controller 48 is present on board the milling machine 12. The control module 44 communicates the data pertaining to the object 40 to the controller 48, if the object 40 is detected beneath the ground surface 14. Additionally, or optionally, the control module 44 communicates the data pertaining to the characteristics of the final cut 42 to the controller 48. The controller 48 receives the data associated with the object 40 and/or the characteristics of the final cut 42 to control one or more functions of the milling machine 12.

When the milling machine 12 is autonomous, the con roller 48 is present onboard the milling machine 12, and may embody a machine control unit of the milling machine 12. Based on the received data, the controller 48 may automatically control a speed, a heading, a gear transmission setting, and so on of the milling machine 12 so as to avoid contact of the milling machine 12, specifically the rotor 30, with the object 40. Also, the controller 48 may automatically control an operation of the rotor 30, such that the rotor 30 is operated in a manner so as to avoid contact of the rotor 30 with the object 40. For example, the controller 48 may control a speed of rotation or a depth of the rotor 30 beneath the ground surface 14 for maintaining clearance between the rotor 30 and the object 40. It should be noted that the controller 48 can also control other linkages or components of the milling machine 12 to avoid contact of the milling machine 12 with the object 40.

In an example in which the milling machine 12 is manually operated, the controller 48 may send the data pertaining to the object 40 as a notification to the operator of the milling machine 12. The notification may be provided on a user interface present in the operator cabin 24 of the milling machine 12. The notification may be a visual notification or an audio notification. In some examples, an alarm may be generated to alert the operator of proximity to the object 40. Based on the notification, the operator may manually control the operation of the milling machine 12 to avoid contact of the milling machine 12 or the rotor 30 with the object 40.

Further, when the milling machine 12 is semi-autonomous, the controller 48 at the remote operator station 16 may generate a notification for the operator at the remote operator station 16. Based on the notification, the operator seated at the remote operator station 16 may remotely control the operation of the milling machine 12 to avoid contact of the milling machine 12 or the rotor 30 with the object 40.

The control module 44 may also receive the second signal indicative of the characteristics of the final cut 42 from the sensor 38. In one example, the control module 44 determines a mill yield of the milling machine 12 based on the characteristics of the final cut 42 received from the sensor 38. In such an example, the control module 44 may store algorithms, mathematical relationships, correlations, or formulae to determine the mill yield on the basis of the detected characteristics of the final cut 42. The mill yield as calculated by the control module 44 may be transmitted to the controller 48. The controller 48 may in turn display the calculated mill yield on the user interface present in the operator cabin 24 and/or the remote operator station 16.

In another example, the information pertaining to the characteristics of the final cut 42 may be transmitted to the controller 48. In such an example, the mill yield may be determined by the controller 48, based on system requirements. Further, the mill yield, as calculated by the controller 48, may be displayed on the user interface in the operator cabin 24 and/or the remote operator station 16.

The control module 44 and/or the controller 48 may embody a single microprocessor or multiple microprocessors. Numerous commercially available microprocessors can be configured to perform the functions of the control module 44 and/or the controller 48. The control module 44 and/or the controller 48 may include all the components required to run an application such as, for example, a memory, a secondary storage device, and a processor, such as a central processing unit or any other means known in the art. Various other known circuits may be associated with the control module 44 and/or the controller 48, including power supply circuitry, signal-conditioning circuitry, solenoid driver circuitry, communication circuitry, and other appropriate circuitry.

### INDUSTRIAL APPLICABILITY

The present disclosure relates to the milling system 34. The milling system 34 allows surveillance of the ground surface 14 around the milling machine 12 to detect the presence of one or more objects beneath the ground surface 14. The milling system 34 detects the presence of the objects before the milling machine 12 may reach a location at which the objects are present, thereby giving sufficient time for controlling the milling machine 12 and/or the rotor 30 so as to avoid contact of the milling machine 12 with the object. In some cases, the UAV 36 may survey the ground surface 14 before the milling machine 12 starts operating so that a route of the milling machine 12 can be planned accordingly. Thus, any potential collision between the milling machine 12 and the object can be avoided, which in turn may greatly reduce a possibility of damage to the milling machine 12, the rotor 30, and/or the cutting tools 32.

The disclosure provides a time and cost efficient system that operates on a real time basis. The milling system 34 can also be used for determining the mill yield. As the sensor 38 of the UAV 36 provides accurate data pertaining to the characteristics of the final cut 42, the disclosure provides an accurate indication of the mill yield.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A milling system for a milling machine operating on a ground surface, wherein the milling machine travels in a first direction on the ground surface, the milling system comprising:
an Unmanned Aerial Vehicle (UAV) communicably coupled to the milling machine, the UAV including a control module and a sensing element, wherein the UAV is configured to:
scan and penetrate a portion of the ground surface proximate to the milling machine along the first direction;
detect if an object is present beneath the portion of the ground surface, based on the scanning; and
transmit data associated with the object, if the object is detected beneath the portion of the ground surface; and
a controller communicably coupled to the UAV and the milling machine, the controller configured to:
receive the data associated with the object; and
control an operation of a rotor of the milling machine based on the received data, such that the rotor is operated in a manner so as to avoid contact with the object.

2. The milling system of claim I, wherein the UAV is further configured to:
scan and penetrate another portion of the ground surface along a second direction, the second direction being different from the first direction, wherein the another portion of the ground surface includes a final cut formed by the milling machine; and
determine one or more characteristics of the final cut based on the scanning for determination of a mill yield of the milling machine.
